(19) United States
(12) Patent Application Publication
(10) Pub. No.: US 2026/0221997 A1
(43) Pub. Date: Jul. 30, 2026

(54) SYSTEM FOR INTELLIGENT RECEIVER DESIGN OF HIGH DOPPLER COMMUNICATION IN PRESENCE OF NON-LINEARITY.

(71) Applicant: INDIAN INSTITUTE OF TECHNOLOGY KHARAGPUR, Kharagpur (IN)

(72) Inventors: Swastik Chakroborty, Kharagpur (IN); Ch. Santosh Reddy, Kharagpur (IN); Debarati Sen, Kharagpur (IN)

(73) Assignee: INDIAN INSTITUTE OF TECHNOLOGY KHARAGPUR, Kharagpur (IN)

(21) Appl. No.: 19/209,362

(22) Filed: May 15, 2025

(30) Foreign Application Priority Data
Jan. 27, 2025 (IN) 202531006696

(51) Int. Cl. H04B 1/12; H04B 17/21; H04L 27/26

(52) U.S. Cl. CPC H04B 1/12; H04B 17/21; H04L 27/2639

(57) ABSTRACT

The present invention discloses a transceiver system for multidimensional modulation-based wireless communication comprising at least a transmitter for multidimensional modulation-based wireless signal transmission and at least an intelligent receiver including an antenna to receive a signal transmitted from said transmitter and an intelligently operating detector to process the received signal including estimating degree of non-linearity in the received signal due to a power amplifier in the transmitter and selectively compensating said non-linearity to improve accuracy for detecting information symbols in the received signal.

### RELATED APPLICATIONS

This application claims priority to India patent application No. 202531006696, Filing Date Jan. 27, 2025, entitled SYSTEM FOR INTELLIGENT RECEIVER DESIGN OF HIGH DOPPLER COMMUNICATION IN PRESENCE OF NON-LINEARITY; which is incorporated herein by reference in its entirety.

### FIELD OF THE INVENTION

The present invention relates to deep learning-based technique for mitigating non-linearities from various sources primarily, but not limited to power amplifiers (PAS) within Orthogonal Time Frequency Space (OTFS) communication systems. More specifically the present invention provides an intelligent receiver unit applicable to transceiver system for multidimensional modulation-based wireless communication which can combine advanced neural network architectures with signal processing techniques to handle non-linearity in the communication signal and enhance system robustness. By utilizing deep learning to improve modeling precision, the receiver unit of the present transceiver system achieves more efficient and accurate non-linear detection in the presence of a high-mobility environment.

### BACKGROUND OF THE INVENTION

Digital pre-distortion is one of the most fundamental building blocks in current wireless communication systems, and it is used to increase the efficiency of the power amplifier. By reducing the distortion generated by the power amplifier when operating in its non-linear region, the efficiency of the power amplifier can be significantly improved. The current polynomial-based digital pre-distortion model cannot accurately describe the power amplifier characteristics at high bandwidth and high PAPR signal inputs. Currently, the pre-distortion based on the neural network is still in the primary research and exploration stage, and because the neural network can fully approximate any complex nonlinear relation, an unknown uncertainty system is learned and self-adaptive, optimal solution is searched at high speed. In the face of future intelligent and open network demands, high-performance and universal digital pre-distortion technology needs to be realized by combining an artificially intelligent algorithm.

In S. Sharma, A. Singh, K. Deka, and C. Adjih, “Impact of Nonlinear Power Amplifier on BER Performance of OTFS Modulation,” 2023 IEEE International Conference on Advanced Networks and Telecommunications Systems (ANTS), Jaipur, India, impact of Non-linearity of Power Amplifier (NPA) and Phase Noise is investigated. The degradation of Bit Error rate (BER) performance w.r.t Signal to Noise Ratio with increasing non-linearity as measured by Input Back-off of the Power Amplifier (PA) is shown in OTFS systems.

In S. G. Neelam and P. R. Sahu, “Error performance of OTFS in the presence of IQI and PA Nonlinearity,” 2020 National Conference on Communications (NCC), Kharagpur, India, 2020 pre-distortion is done at the transmitter side to correct non-linearity. A two-step process is formulated to estimate and correct the IQ Imbalance and PA Nonlinearity by using Tx side predistortion. Classical pre-distortion in the case of a high-mobility OTFS scenario lends itself to prohibitive computational costs.

In Y. Chen, L. Zhao, Y. Jiang, W. Li, H. Gao, and C. Liu, “OTFS waveform based on 3-D signal constellation for time-variant channels,” IEEE Communications Letters, 2023 3D Constellation for M-QAM is proposed. Different 3D shapes are used to define the constellation, and those are as follows: a regular tetrahedron for the 4-order signal constellation, two cubes with unequal sides for the 16-order, a four-layer structure each with four rows and four columns having equal distance from two adjacent points for 64-order, and a layered cross-shaped for the 128-order. The designed OTFS frame is padded with zeros to make it a square-shaped frame, which is overhead at the receiver. The designed system does not take care of the 3GPP standards.

In J. Xu, K. Said, L. Zheng and L. Liu, “Neural Network-Based Two-Dimensional Filtering for OTFS Symbol Detection,” ICC 2024-IEEE International Conference on Communications, Denver, CO, USA, 2024 a reservoir computing (RC) based approach has been introduced for online subframe-based symbol detection in the OTFS system, where only the limited over-the-air (OTA) pilot symbols are utilized for training.

In Y. K. Enku et al., “Two-Dimensional Convolutional Neural Network-Based Signal Detection for OTFS Systems,” in IEEE Wireless Communications Letters, vol. 10, no. 11, pp. 2514-2518 November 2021, Two-Dimensional Convolution Neural Network (2D-CNN) detector for OTFS is proposed in 2D delay Doppler domain. Data Augmentation is used to improve learning.

CN201510566527 discloses a method to linearize NPA output in Orthogonal Frequency Division Multiplexing (OFDM) system. Pre-distortion is analytically performed in the frequency domain by sending a test signal, determining the distortion value, and then sending the actual data. The OFDM system is considered unsuitable for high-mobility environments.

US20240007332 A1 discloses a nonlinear detector for a practical non-ideal power amplifier in mmWave OTFS systems in high mobility applications. A nonlinear detection scheme based on a combination of maximal-ratio combining and particle filter is proposed that equalizes the channel and recovers the transmitted QPSK/QAM signal from the distorted observations in the delay-Doppler domain. With receiver beamforming, the relation between input-output with nonlinearity is established, which aids in developing the nonlinear detector.

U.S. Pat. No. 9,379,745B2 proposes a digital predistorter configured to output a predistorted digital signal. The digital predistorter uses an adaptive polynomial-based digital predistortion system to generate at least one pre-distortion coefficient. The rest of the coefficients are generated by a lookup table based on finite impulse response filters with at least one coefficient coming from (2). While wideband communication systems using complex modulations like WCDMA and OFDM are addressed, OTFS is not.

US20210326701A1 proposes any wireless communication system can have a machine learning module in any of the layers in the protocol stack. In the system, the nodes collect the measurements related to wireless communications and get trained to produce a reliable system. The UE in the system reports its capability to the server and uses the feedback from the server to update its neural network.

CN114565077B provides a deep neural network generalization modeling method for a power amplifier in the OFDM system. The invention realizes modeling of multiple groups of power amplifier signals with different bandwidth and power levels, avoiding the problem that network models need to be trained one by one in a targeted manner when OFDM signals with different bandwidth and power conditions exist, reduces the number of models to be modeled, and dramatically improves the modeling efficiency.

It is thus there has been a need for developing an improved artificially intelligent detection method based on a neural network, which will combine an intelligent neural network algorithm, considers the characteristics of input parameters from different dimensions, efficiently and accurately establishes a unified model, well compensates the nonlinear characteristics of the power amplifier, and reduces in-band distortion and adjacent channel interference in the time-varying channels. Meanwhile, the neural network will have simple implementation structure and high expandability.

### OBJECT OF THE INVENTION

It is thus the basic object of the present invention is to develop a deep learning-based technique for mitigating non-linearities from various sources primarily, but not limited to power amplifiers (PAS) within Orthogonal Time Frequency Space (OTFS) communication systems.

Another object of the present invention is to provide an intelligent receiver unit applicable to transceiver system for multidimensional modulation-based wireless communication which can combine advanced neural network architectures with signal processing techniques to handle non-linearity in the communication signal and enhance system robustness.

Yet another object of the present invention is to develop a novel neural network-based receiver is designed for the OTFS communication system that can jointly estimate the transmitter side non-linearity at the receiver, correct it at the receiver itself, and detect the transmitted symbol thereafter.

Yet another object of the present invention is to develop a novel neural network-based receiver is designed for the OTFS communication system that eliminates the need to predict the non-linearity at the transmitter and attempts to pre-distort it.

### SUMMARY OF THE INVENTION

Thus, according to the basic aspect of the present invention there is provided a transceiver system for multidimensional modulation-based wireless communication comprising
at least a transmitter for multidimensional modulation-based wireless signal transmission; and
at least a receiver including an antenna to receive a signal transmitted from said transmitter and an intelligently operating detector to process the received signal including estimating degree of non-linearity in the received signal due to a power amplifier in the transmitter and selectively compensating said non-linearity to improve accuracy for detecting information symbols in the received signal.

In the above transceiver system, the transmitter comprises
a N-Dimensional (N-D) signal mapper 100 followed by an I/Q converter 110, and a modulator 120 that modulates complex information symbols arranged in any domain to time domain samples; and
a power amplifier (PA) 130 to boost the time domain samples sufficient to travel long distances without significant attenuation during transmission by antenna or group of antennae.

In the above transceiver system, bits in the signal mapper 100 are arranged in N-parallel lines and each is mapped to an information symbol from Q symbol where Q-order N-D signal mapper maps the bits as

$${X}_{N - D} = [ \begin{matrix}{β}_{11} & {β}_{21} & … & {β}_{p 1} \\ {β}_{12} & {β}_{22} & & {β}_{p 2} \\ & ⋮ & ⋱ & ⋮ \\ {β}_{1 N} & {β}_{2 N} & … & {β}_{pN}\end{matrix} ]$$

where p=(2UV log₂ Q)/N;
wherein the I/Q converter 110 generates the I/Q samples from the X_{N-D} that can be transmitted in a digital communication.

In the above transceiver system, the modulator 120 includes
OTFS modulator 200 where the I/Q symbols are modulated to time domain signal from delay-Doppler domain symbols whereby the I/Q symbols assuming to be in the delay-Doppler domain are subjected for OTFS modulation using inverse symplectic fast Fourier transform (ISFFT) 201 and OFDM modulator 202; or
OFDM modulator 210 where the I/Q symbols assuming to be in frequency domain are modulated to time domain signal.

In the above transceiver system, the antenna or group of antennae converts electrical signal into electromagnetic waves for propagating through a channel 140.
In the above transceiver system, the receiver includes
a low noise amplifier (LNA) 150 to amplify the received signals in the antenna with minimal additional noise;
said detector 160 for artificial intelligence-based symbol detection;
a N-D converter 170; and
a N-D signal demapper 180.

In the above transceiver system, the detector 160 comprises
a demodulator 161,
an equalization and detection unit 162; and
switching elements for executing Neural Network (NN) based detectors and ML-based detector for selective incorporation in detecting the information symbols including switches to the ML-based detector when estimated SNR and Input Backoff (IBO) cross a threshold of SNR>20 dB and IBO>20 dB and switches to the NN-based detector when SNR<20 dB and/or IBO<20 dB (moves to non-linear region).

In the above transceiver system, the demodulator 161 includes
OTFS demodulator 300 to transform the signal into delay-Doppler domain symbols from the time domain signals having OFDM demodulator 301 that transforms the time domain signal into the time-frequency domain, and symplectic fast Fourier transform (SFFT) 302 to get back the delay-Doppler domain symbols therefrom; or
OFDM demodulator 310 when the corresponding transmitter modulator is the OFDM modulator 210.

In the above transceiver system, the equalization and detection unit 162 is configured for jointly equalize and detect the symbols in the presence of the nonlinear effect of the power amplifier.

In the above transceiver system, the detector 160 executes NN based detectors having two-stages whose first stage estimates non-linearity coefficient of the power amplifier from the symbol, and the second stage takes the symbol and the estimated non-linearity coefficient to detect and output transmitted message in a one-hot encoded form;
wherein switches (a) and (b) of the detector 160 are in closed state to enable direct feeding of received time domain signal to calculating-NN-model element 400 for the IBO calculation and using the estimated IBO in detection-NN-model element 410 to decode symbols and outputting the transmitted message signal.

In the above transceiver system, the detector 160 executes NN based detectors having two-stages whose first stage estimates the non-linearity coefficient of the power amplifier from the received frame, which contains multiple symbols, and the second stage detects the original transmitted message in a one-hot encoded form by taking the frame and the estimated non-linearity coefficient from the first stage as inputs;
wherein switches (a) and (b) of the detector are in closed state which involves the detection-NN-model 410 to process entire frames of the OTFS symbols together to predict transmitted message frame by frame.

In the above transceiver system, wherein the detector 160 executes Maximum Likelihood based detector having two stages in which the first stage estimates the non-linearity coefficient of power amplifier and in the second stage the said value of non-linearity is used to detect from the demodulated symbols and output the transmitted multidimensional symbols;
wherein the switches (a) and (c) in the detector 160 are in the closed state which involves the demodulator 161 to demodulate the received time domain signal and fed the same for data detection that has input from the calculating-NN-model element 400.

In the above transceiver system, wherein the detector 160 has two stages of operation, wherein the non-linearity of the transmitting power amplifier is estimated by a calculating-NN-model in first stage and the said value is used by the detecting-NN-model along with the demodulated symbols which are output from the demodulator 161, to detect the original transmitted multidimensional symbols;
wherein the switches (a) and (d) of the detector 160 are in the closed state, whereby equalization is performed at the demodulated symbols and fed to ML detector 430 along with the estimated IBO enabling NN model 430 to take the input as [symbol] and [symbol] and IBO.

In the above transceiver system, wherein the detector 160 executes an OTFS demodulator followed by a joint block of ML detector and Particle Filter (PF), whereby raw received signals are first demodulated using the demodulator 161 and then the demodulated symbols are used by the joint ML detector and PF to detect the original transmitted symbol, said PF takes a probabilistic approach of updating weight of each particle based on its likelihood relative to the observed symbols;
wherein the switch (e) of the detector 160 are in the closed state, whereby the estimated OTFS symbols are passed to joint ML detector and particle filter 440 to nullify nonlinearity due to the power amplifier and estimate the transmitted multi-dimensional symbols.

In the above transceiver system, the N-D converter 170 performs inverse operation of the I/Q converter 110 after estimating the symbol and the N-D signal de-mapper 180 demaps the symbol points in the N-D constellation using minimal distance judgment, the detected symbols are converted back to a stream of bits, whereby UE/BS receives the required information bits.

### BRIEF DESCRIPTION OF THE DRAWINGS

FIG. 1 Wireless communication system with the multi-dimensional modulation and power amplifier FIG. 2 Different modulators in the wireless communication system

FIG. 3 Different demodulators in the wireless communication system

FIG. 4 Different demodulators in the wireless communication system

FIG. 5: A symbolwise neural network based joint non-linearity estimator and detector FIG. 6: Neural Network based symbolwise non-linearity estimator FIG. 7: Neural Network based modified symbolwise detector FIG. 8: A framewise neural network based joint non-linearity estimator and detector

FIG. 9: Neural Network based framewise non linearity estimator

FIG. 10: Neural Network based modified framewise detector

FIG. 11: Bit Error Rate vs IBO plot for 16-QAM at SNR=20 dB for various user velocities

FIG. 12: BER v SNR plot for 16-QAM at user velocity of 100 km/h for various IBO values

### DETAILED DESCRIPTION OF THE INVENTION

The invention provides a receiver system for high Doppler communication in presence of non-linearity by using an artificial intelligent detection method based on a neural network, which combines an intelligent neural network algorithm, considers the characteristics of input parameters from different dimensions, efficiently and accurately establishes a unified model, well compensates the nonlinear characteristics of the power amplifier, and reduces in-band distortion and adjacent channel interference in the time-varying channels. Meanwhile, the neural network has a simple implementation structure and high expandability.

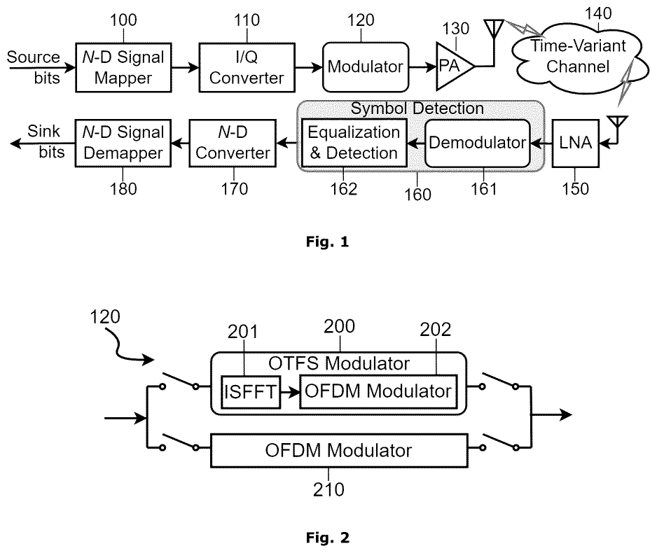

With respect to the above-mentioned scenario, embodiments of the present invention are described in further detail below with reference to the accompanying drawings, wherein reference numerals designate identical or corresponding parts throughout the several views. FIG. 1 shows an embodiment of a transceiver system for the multidimensional modulation-based wireless communication. The highlighted block corresponds to the core operating units of the present invention. The transmitter of system comprises N-Dimensional (N-D) signal mapper 100, followed by an I/Q converter 110, and a modulator 120 that modulates the complex information symbols arranged in any domain to the time domain samples.

The transmitter generally targets a particular scenario. For instance, a payload size of A is intended to be transmitted to a UE or the payload is received by the BS. In the N-D signal mapper 100, bits are arranged in N-parallel lines, and then each column is mapped to a symbol from the Q symbol. The Q-order N-D signal mapper maps the bits, which is given as

$${X}_{N - D} = [ \begin{matrix}{β}_{11} & {β}_{21} & … & {β}_{p 1} \\ {β}_{12} & {β}_{22} & & {β}_{p 2} \\ & ⋮ & ⋱ & ⋮ \\ {β}_{1 N} & {β}_{2 N} & … & {β}_{pN}\end{matrix} ] .$$

where p=(2UV log₂ Q)/N. An I/Q converter 110 generates the I/Q samples from the X_{N-D} that can be transmitted in a digital communication system. The expression for the I/Q converter is given as

$${x}_{I / Q} ( i ) = {x}_{N - D} ( 2 i ) - {jx}_{N - D} ( 2 i + 1 )$$

where x_{N-D}=vec (X_{N-D}). In some embodiments, the information bits can undergo different source coding and channel coding techniques before generating the I/Q samples,

FIG. 2 shows the modulation techniques (in 120) that can be used in the wireless communication system. In OTFS modulator 200, the I/Q symbols modulated to the time domain signal from the delay-Doppler domain symbols. For the OTFS modulation, the I/Q symbols are assumed to be in the delay-Doppler domain, and using inverse symplectic fast Fourier transform (ISFFT) 201 and OFDM modulator 202, they modulated to time domain signal. The modulator can also be used for the OFDM system, where the I/Q symbols are assumed to be in the frequency domain and modulated to the time domain signal using OFDM modulator 210.

In the present embodiments, the modulator 120 uses the OTFS modulator 200. So, the I/Q samples are assumed to be the delay-Doppler domain and arranged in an adaptive OTFS frame format as S∈C^{U×V}. The OTFS frame has U delay samples and V Doppler samples. The transmitted time-domain signal for OTFS modulation 120 in vector form can be written as

$$s = ( {F}_{V}^{H} ⊗ {G}_{tx} ) {x}_{I / Q} .$$

Where Gₜₓ is the transmitting pulse shaping, and is Fᵥ 2D-DFT matrix. For the easier understanding of the invention in the Artificial intelligence-based detector design in presence of nonlinearity in high mobility environments we have considered rectangular pulse shaping waveform, hence Gₜₓ=Iᵥ. However, our invention is not limited to the type of pulse shaping used in the system.

The time domain vector s subsequently passes through the power amplifier (PA) 130 to boost its strength, ensuring it can travel long distances without significant attenuation. Due to the nonlinear characteristics of the PA, the modulated signals undergo in-band distortion and out-of-band spectral leakage. The transmitted nonlinearly distorted OTFS sample [symbol] (n) in n^{th} time instant is represented as

$$\text{?} ( n ) = G ( \vert s ( n ) \vert ) {e}^{j {Φ}_{s ( n )} + j Ψ ( \vert s ( n ) \vert )}$$

where s(n) is the time-domain OTFS sample at n^{th} instant;

$$G ( \vert s ( n ) \vert ) = g \vert s ( n ) \vert {/ [ 1 + {( g \vert s ( n ) \vert / {V}_{sat} )}^{2 {σ}_{p}} ]}^{\frac{1}{2 {σ}_{p}}}$$

is the amplitude distortion defined by amplitude modulation-amplitude modulation (AM/AM) and Ψ(|s(n)|)=κ|s(n)|^{\tilde{q}1}/[1+(|s(n)|/β)^{\tilde{q}2}] is the additional phase distortion defined by amplitude modulation-phase modulation (AM/PM), according to modified Rapp model of mmWave power amplifier. Vₛₐₜ represents the saturation voltage of power amplifier; g and σₚ are the linear gain and smoothness factor, respectively of power amplifier. Other parameters κ, β, \tilde{q}₁, and \tilde{q}₂ are power amplifier parameters; Φₛ₍ₙ₎ denotes the phase of s(n).

The degree of distortion from the power amplifier is defined by input back off (IBO) which is expressed as −10 log₁₀(pᵢ/pₛₐₜ), where pᵢ is input signal power to power amplifier and pₛₐₜ is saturation power. Lower IBO constitutes a higher nonlinear distortion from the power amplifier.

The amplified signal is then transmitted via an antenna or group of antennae, which converts the electrical signal into electromagnetic waves propagating through the time-varying channel 140. Here, the embodiment is not limited to only the time-varying channel.

Moreover, in other embodiments, the channel can be multicast or broadcast and may be employed as a one-directional or bi-directional channel and may be relayed (with amplify and forward, decode and forward). In other embodiments, transmit and receiving beamforming or any combination of analog and digital beamforming can boost the signal strength.

The nonlinearly distorted transmit OTFS signal propagates through the high mobility multipath fading channel 140 and will experience a Doppler shift. These signals are typically weak, so they are fed into a low noise amplifier (LNA) 150, which amplifies the signals with minimal additional noise. The received signal after the LNA 150 is written in matrix format and is given as

$${y}^{⌣} = H \hat{s} + {w}^{⌣}$$

where \tilde{w} is the AWGN in the time domain and H is the UV×UV channel matrix with P multipath defined as

$$H = {\sum }_{i = 1}^{P} {h}_{i} {\prod }^{{l}_{i}} {Δ}^{{k}_{i}}$$

where, hᵢ is the complex path gain in i-th path. Let τᵢ and vᵢ be the delay and Doppler shift associated with the i-th path. Then the normalized delay and Doppler shift index for the i-th path are given by lᵢ=τᵢUΔf, kᵢ=vᵢVT, where Δf=1/T is subcarrier space. The practical delays and Doppler frequency shifts are approximated to the nearest points of the grid in the DD domain. In the channel matrix nu as the permutation matrix (forward cyclic shift), and Δ^{k}^{ₗ}=diag(z⁰, z¹, . . . , z^{UV-1}) with z=exp(j2π/UV) models the delay and Doppler shifts, respectively.

The receiver system of the present invention consists of the design and implementation of the artificial intelligence-based symbol detector in 160 which comprises a demodulator 161 and the equalization and detection 162.

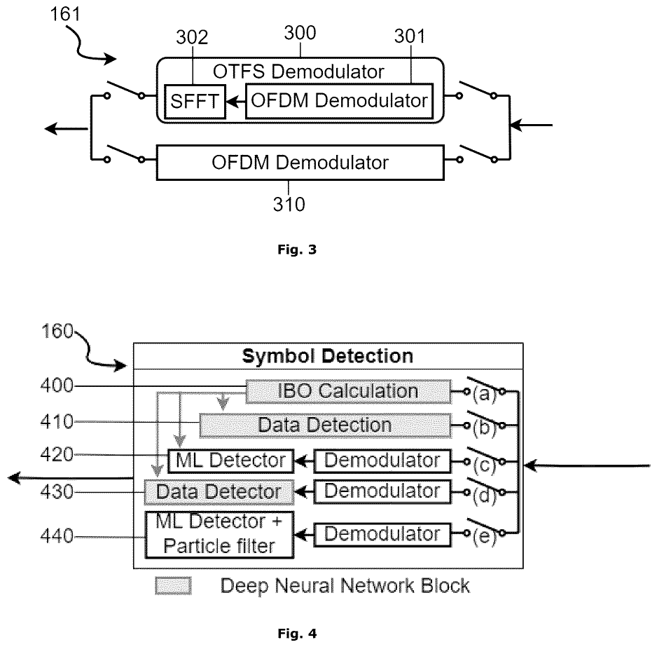

FIG. 3 shows the different demodulation techniques used in the wireless communication systems. In the OTFS demodulator 300, the signal is transformed to delay-Doppler domain symbols from the time domain signals. The OFDM demodulator 301 transforms the time domain signal into the time-frequency domain, and then the symplectic fast Fourier transform (SFFT) 302 is used to get back the delay-Doppler domain symbols. Moreover, some systems use the OFDM demodulator 310 when the modulator is 210. In the 162 stage, distortions introduced by the channel, such as multipath fading or inter-symbol interference (ISI), are corrected. Equalization compensates for these channel effects, while detection decodes the received symbols into corresponding signals. In some embodiments, joint equalization and detection can be used to detect the transmitted symbols. In the present invention, the NN model is used to jointly equalize and detect the transmitted symbols in the presence of the nonlinear effect of the power amplifier.

The neural network can be used in different structures for symbol detection. As an innovation, the NN is used to estimate the quantity of non-linearity at the receiver that can be used to enhance the detection quality of the demodulated or equalized symbols, as shown in FIG. 4.

In one embodiment of symbol detector 160, the types of detector selection is handled by the switches, that helps in operating in different estimated IBO and SNR values.

In one embodiment of symbol detector 160, the NN for IBO calculation 400 is used to quantify the received system's nonlinearity.

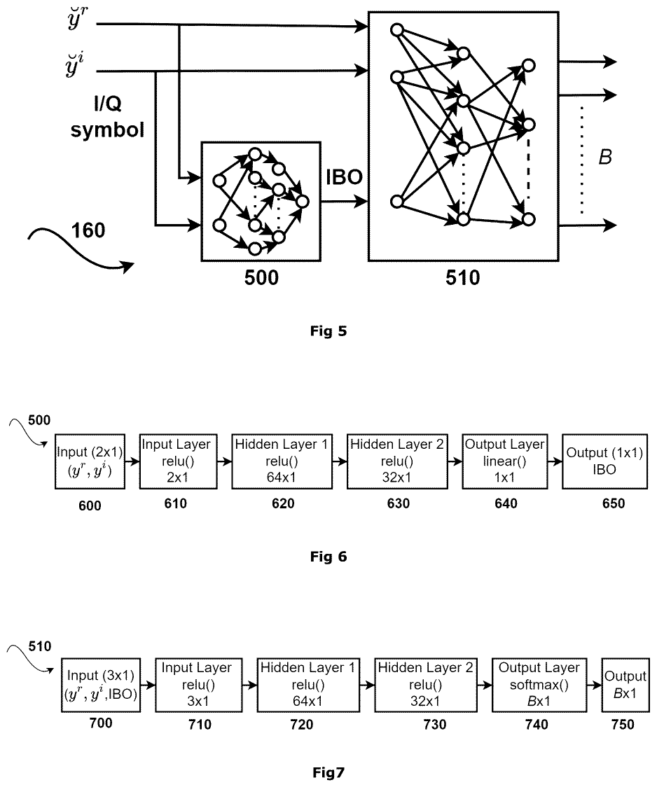

In another embodiment of 160, switches (a) and (b) are closed. Here the received time domain symbol is directly fed to the NN and the estimated IBO from 400 for the symbol detections. We use neural networks to decode symbols using the received OTFS time domain signal sample-by-sample on the receiver side. Each modulated symbol y̌ is split into real and imaginary parts as y̌^{r} and y̌ⁱ which serve as inputs to both blocks 400 and 410 as shown in FIG. 5. The particular neural network in 510 has 2 inputs for y̌^{r} and y̌ⁱ. The number and size of the intervening hidden layers of the neural network are chosen after careful experimentation. We take 2 hidden layers with 16 and 32 neurons, respectively. The symbolwise IBO estimator 500 is expanded in FIG. 6 to give the detailed view of the neural network. The input and hidden layers use Rectified Linear Unit (ReLU) activation function while the output uses a linear activation function as we are estimating the value of non-linearity, and hence the problem is a regression problem.

Block 510 is a modified detector block that will output the message signal in a one-hot encoded form. The neural network has three inputs: for y̌^{r} and y̌ⁱ and the estimated IBO from 500. The estimated non-linearity value of the symbol is fed to the detector block along with the two message symbols. Two hidden layers have 64 and 32 neurons each. In the output layer, there is B=(2/N)log₂ Q output where B is the size of the modulation alphabet, i.e., the number of possible symbols in the constellation of that particular Q-QAM modulation.

FIG. 7 provides a detailed view of the Block 510. The input layer has 3 inputs the real, imaginary parts of the symbol and the estimated IBO value. Here, we also use the ReLU activation function in input layer 710 and hidden layers 720 and 730 while 740 uses a softmax activation function. Softmax is best suited for one-hot classification problems like this as one of the B neurons in 740 will have a high value while other neurons values will vanish.

The two neural networks, 400 and 410, are both trained in tandem with the same training set, which contains the received symbol (y̌^{r}, y̌ⁱ) as input and one-hot encoded message sequence. The learning rate is set at 0.0001 for both neural networks.

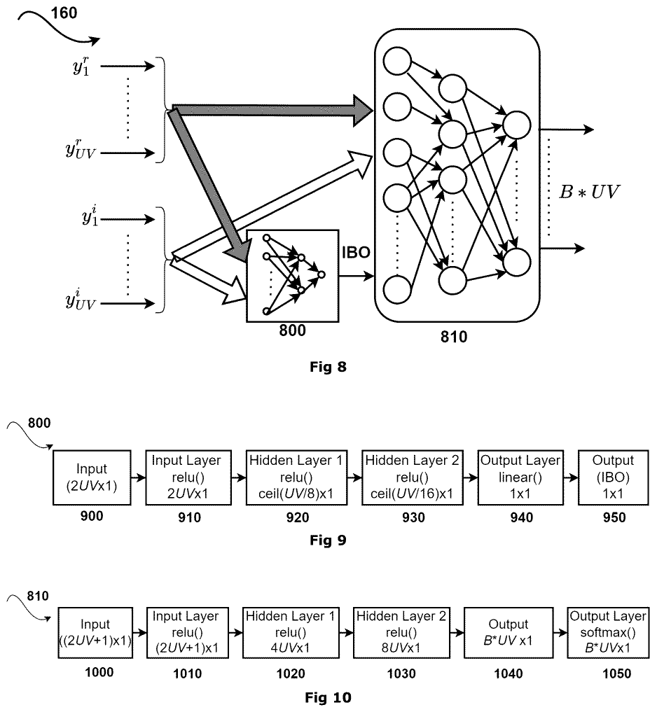

In another embodiment of the 160, switches (a) and (b) are closed, where we propose an NN-based detector in 410 that will process entire frames of OTFS symbols together to predict the transmitted message frame by frame. In this framewise implementation of block 410, we pass the entire frame, which contains UV symbols. The expansion of this system is shown in FIG. 8. In neural network 800, the network takes the entire frame containing 2UV symbols as the input is divided into real and imaginary parts. The block in 800 outputs a single scalar value, IBO, which represents the non-linearity of the power amplifier. The expanded view of 800 is given in FIG. 9. Input layer 910 uses a ReLU activation. There are two hidden layers 920 and 930. The hidden layers have ceil (UV/8) and ceil (UV/16) neurons and also use ReLU function.

The output layer 940 uses a linear activation function as only one scalar, IBO needs to be estimated. The output of 800 serves as one of the inputs for 810. There are a total of 2UV+1 inputs for block 810. An expanded view of 810 is provided in FIG. 10. The input layer (1010) has a ReLU activation function. Similarly, hidden layers (1020 and 1030) have a ReLU activation function.

The output dimension for the neural network is BUV. The output needs to be one-hot encoded so each symbol corresponds to B neurons in the output layer, of which only one will fire at a time. There are UV such symbols in the frame. Thus, we need BUV output neurons. As this is a symbol classification problem, we will use the softmax activation function.

In another embodiment of 160, switches (a) and (c) are closed. The received time domain signal is demodulated using 161 and fed to the data detection that has input from the 400. At the receiver, the received time-domain signal passes through the OTFS demodulator 161 to get back the DD domain representation of transmitted information. So, the input-output relation in the DD domain is given as

$${r}^{⌣} = ( {F}_{V} ⊗ {I}_{U} ) {y}^{⌣} .$$

So, the symbols are estimated in the delay-Doppler domain with predicted IBO quantity.

In one embodiment of the 160, switches (a) and (d) are closed. Here the equalization is performed at the demodulated symbols and fed to the ML detector 430 along with the estimated IBO from 500. The demodulated signal is equalized in the delay-Doppler domain and given as

$$\text{?} = {( {H}_{eff}^{H} {H}_{eff} + {σ}^{2} {I}_{UV} )}^{- 1} {H}_{eff}^{H} {r}^{⌣} .$$

### Where

$${H}_{eff} = ( {F}_{V} ⊗ {I}_{U} ) H ( {F}_{V}^{H} ⊗ {I}_{U} )$$

is the effective channel matrix of size UV×UV. So, the NN at the 430, take the input as [symbol] and [symbol] and IBO.

In another embodiment of the 160, switch (e) is closed. Here the estimated OTFS symbols are passed to the joint ML detector and particle filter 440 to nullify the nonlinearity due to the power amplifier and estimate the transmitted multi-dimensional symbols.

After estimating the symbol, the N-D converter 170 performs the inverse operation of the I/Q converter 110 and produces, \tilde{X}_{I/Q}, and the N-D signal de-mapper 180 demaps the symbol points in the N-D constellation using minimal distance judgment which is given as

$${\tilde{X}}_{N - D} ( p ) = arg {max}_{{p}_{q} ϵ {Q}_{N - D}} \vert {p}_{q} - {\tilde{X}}_{I / Q} ( p ) \vert$$

The detected symbols are converted back to a stream of bits. At the end of the procedure, the UE/BS receives the required information bits.

### Results and Discussion

In this section, we illustrate the performance in terms of bit error rate (BER) of an Artificial intelligence-based symbol detector in the presence of the non-ideal power amplifier and the high mobility channel. Further, we have compared the performance of the AI detector with a baseline of the classical Maximum Likelihood (ML) detector as shown in 420 in FIG. 4. Here, we have used the OTFS modulator with V=14 Doppler samples and subcarriers U=12 delay samples. The carrier frequency is 4 GHz, and the subcarrier spacing is 15 kHz. The information symbol is modulated by Q modulation order in different dimensions. For the channel model, we adopt the power delay profile of the Extended Vehicular A model (EVA) with a delay spread of 66 ns. Each delay tap has a single Doppler shift generated using Jake's formula: vᵢ=vₘₐₓ cos(θᵢ), where vₘₐₓ is the maximum Doppler shift determined by the IoT device speed and θᵢ is uniformly distributed over [−π, π]. The system is evaluated at extreme Doppler shift conditions, so at lower Doppler shifts, the proposed system will show improved or near-extreme Doppler situations. The underlying modulation in the OTFS that we will be using is 16-QAM. Using higher modulation order enables us transmit bits faster albeit at the cost of higher error rate. Thus, we choose 16QAM to balance the considerations of accuracy and high data rate.

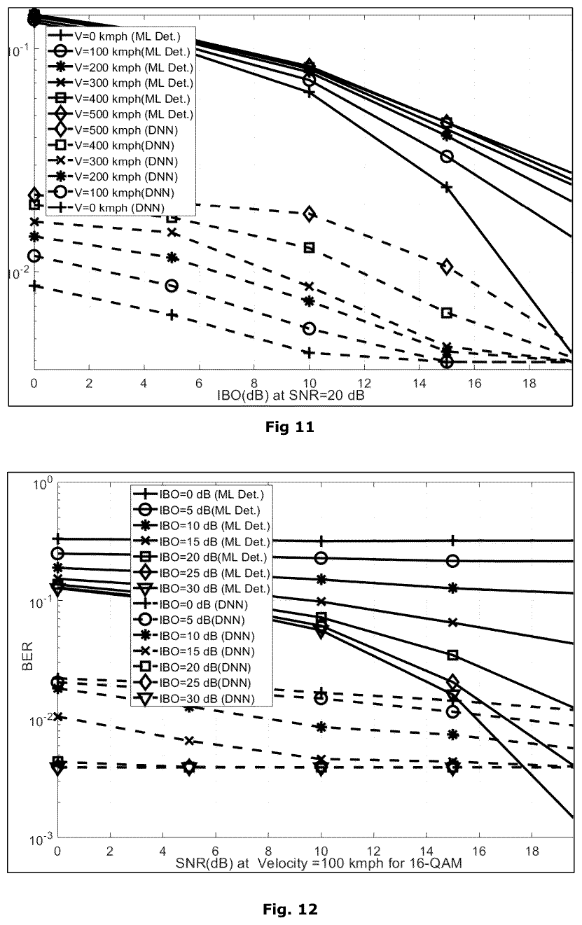

To validate our proposal, we simulate the BER performance of the transceiver shown in FIG. 1 with the implementation of 160, as shown in FIG. 8. Thus, we follow a frame-by-frame neural network-based non-linearity estimation and symbol detection framework. The transmit SNR is set at 20 dB, and the non-linearity of the power amplifier is varied by varying the IBO, is shown in FIG. 11. The performance is evaluated at SNR 20 dB. It can be observed from the figure that with the increase in the velocity at a given IBO, the BER performance degrades due to the increased Doppler frequency. However, as the IBO increases, the BER performance of the system improves due to the decrease in the nonlinearity in the received signal. At 0 dB IBO, maximum non-linear distortion occurs, and the higher the value of IBO, the lower the nonlinearity of the power amplifier. We conduct this experiment at various velocities of the users i.e. the receivers. The velocity of the users is limited to a maximum of 500 km/h. The experiment is conducted with two different kinds of receivers 420 and 430 which can be switched as shown in FIG. 4. While 420 is a Deep Neural Network (DNN) based detector, 430 is a Classical Maximum Likelihood (ML) detector. With increasing IBO, the extent of non-linear distortion reduces as the amplifier response becomes more linear, and thus, detection performance also improves.

We observe that the DNN based detector consistently outperforms the ML based detector in all values of velocity upto 500 kmph at a non-linearity of upto 20 dB IBO. The DNN based detection is much more robust to variations in velocity and non-linear distortion while in the ML based detection, the performance gap between high velocity, high non-linearity and low velocity, low non-linearity is much more significant.

FIG. 12 shows the variation of the same Bit Error Rate with varying SNR at a fixed user velocity of 100 km/h. We consider various values of transmitter Power Amplifier non-linear distortion quantified by the values of IBO ranging from 0 dB to 30 dB. We conduct our experiment as previously using both detector 420 and 430 i.e. the DNN based detector and the ML detector.

As is evident from the graph our DNN based detector outperforms the ML based detector in up to IBO=20 dB for all values of SNR (0-20 dB). Thus, in scenarios with high to moderate non-linarites the DNN based detector provides better BER at a non-trivial user velocity of 100 kmph. However, in higher values of IBO i.e. when the power amplifier is close to being linear and when the transmit SNR is high, the good conditions of communication make ML based detector a better choice as it's BER falls below the baseline offered by the DNN. Thus, if the transmit SNR is high i.e. above 20 dB and transmit power amplifier IBO>20 dB the DNN based detector experiences diminishing returns in terms of BER performance whereas the ML based detector shows much more significant improvement. Thus, in the SNR>20 dB and IBO>20 dB regime switching to the ML detector as shown in FIG. 4 is the recommended course of action.

Thus, in scenarios with high to moderate non-linarites the DNN based detector provides better BER at a non-trivial user velocity of 100 kmph. However, in higher values of IBO i.e. when the power amplifier is close to being linear and when the transmit SNR is high, the good conditions of communication make ML based detector a better choice as it's BER falls below the baseline offered by the DNN. Thus, if the transmit SNR is high i.e. above 20 dB and transmit power amplifier IBO>20 dB the DNN based detector experiences diminishing returns in terms of BER performance whereas the ML based detector shows much more significant improvement.

Thus, in the SNR>20 dB and IBO>20 dB regime switching to the ML detector as shown in FIG. 9 is the recommended course of action.

Thus, from FIGS. 11 and 12 we observe that, when the amplifier is highly non-linear the DNN based detector makes communication possible at a lower BER than classical detector even if the user velocity is high and/or the SNR is low. This demonstrates the utility of our invention in providing accurate communication at conditions that may not be conducive for communication with the state-of-the art detectors as shown.

### The Advantages of the Present Invention can be Summarized as Follows

1. The neural network-based approach used in this solution is a low-complexity solution that, when trained, can predict the symbols at a much lower complexity than using a combination of classical pre-distortion, estimation, and detection.

2. It eliminates the need for separate blocks for pre-distortion at the transmitter, channel estimation, and symbol detection block at the receiver, wherein the two-stage neural network block can perform the task of all three blocks together.

3. Due to the intelligent nature of the receiver, it can adapt to a wide variety of user velocity and channel conditions.

4. As two implementations are provided in this invention, it covers both high-velocity and low-velocity regimes and thus provides satisfactory performance at a wide range of velocities.

5. Due to the high tolerance of non-linearity in the design, it functions satisfactorily at very high degrees of non-linearity. Cheap but highly non-linear power amplifiers can be used at the transmitter if the proposed neural network block is used at the receiver, bringing down transmitter cost.

1. A transceiver system for multidimensional modulation-based wireless communication comprising
at least a transmitter for multidimensional modulation-based wireless signal transmission; and
at least a receiver including an antenna to receive a signal transmitted from said transmitter and an intelligently operating detector to process the received signal including estimating degree of non-linearity in the received signal due to a power amplifier in the transmitter and selectively compensating said non-linearity to improve accuracy for detecting information symbols in the received signal.

2. The transceiver system as claimed in claim 1, wherein the transmitter comprises
a N-Dimensional (N-D) signal mapper 100 followed by an I/Q converter 110, and a modulator 120 that modulates complex information symbols arranged in any domain to time domain samples; and
a power amplifier (PA) 130 to boost the time domain samples sufficient to travel long distances without significant attenuation during transmission by transmission antenna or group of antennae.

3. The transceiver system as claimed in claim 2, wherein bits in the signal mapper 100 are arranged in N-parallel lines and each is mapped to an information symbol from Q symbol where Q-order N-D signal mapper maps the bits as
$${X}_{N - D} = [ \begin{matrix}{β}_{11} & {β}_{21} & … & {β}_{p 1} \\ {β}_{12} & {β}_{22} & & {β}_{p 2} \\ & ⋮ & ⋱ & ⋮ \\ {β}_{1 N} & {β}_{2 N} & … & {β}_{pN}\end{matrix} ] .$$
where p=(2UV log₂ Q)/N;
wherein the I/Q converter 110 generates the I/Q samples from the X_{N-D} that can be transmitted in a digital communication.

4. The transceiver system as claimed in claim 2, wherein the modulator 120 includes
OTFS modulator 200 where the I/Q symbols are modulated to time domain signal from delay-Doppler domain symbols whereby the I/Q symbols assuming to be in the delay-Doppler domain are subjected for OTFS modulation using inverse symplectic fast Fourier transform (ISFFT) 201 and OFDM modulator 202; or
OFDM modulator 210 where the I/Q symbols assuming to be in frequency domain are modulated to time domain signal.

5. The transceiver system as claimed in claim 2, wherein the transmission antenna or group of antennae converts electrical signal into electromagnetic waves for propagating through a channel 140.

6. The transceiver system as claimed in claim 1, wherein the receiver includes a low noise amplifier (LNA) 150 to amplify the received signals in the antenna with minimal additional noise;
said detector 160 for artificial intelligence-based symbol detection;
a N-D converter 170; and
a N-D signal demapper 180.

7. The transceiver system as claimed in claim 6, wherein the detector 160 comprises
a demodulator 161,
an equalization and detection unit 162; and
switching elements for executing Neural Network (NN) based detectors and ML-based detector for selective incorporation in detecting the information symbols including switches to the ML-based detector when estimated SNR and Input Backoff (IBO) cross a threshold of SNR>20 dB and IBO>20 dB and switches to the NN-based detector when SNR<20 dB and/or IBO<20 dB (moves to non-linear region).

8. The transceiver system as claimed in claim 7, wherein the demodulator 161 includes
OTFS demodulator 300 to transform the signal into delay-Doppler domain symbols from the time domain signals having OFDM demodulator 301 that transforms the time domain signal into the time-frequency domain, and symplectic fast Fourier transform (SFFT) 302 to get back the delay-Doppler domain symbols therefrom; or
OFDM demodulator 310 when the corresponding transmitter modulator is the OFDM modulator 210.

9. The transceiver system as claimed in claim 7, wherein the equalization and detection unit 162 is configured for jointly equalize and detect the symbols in the presence of the nonlinear effect of the power amplifier.

10. The transceiver system as claimed in claim 6, wherein the detector 160 executes NN based detectors having two-stages whose first stage estimates non-linearity coefficient of the power amplifier from the symbol, and the second stage takes the symbol and the estimated non-linearity coefficient to detect and output transmitted message in a one-hot encoded form;
wherein switches (a) and (b) of the detector 160 are in closed state to enable direct feeding of received time domain signal to calculating-NN-model element 400 for the IBO calculation and using the estimated IBO in detection-NN-model element 410 to decode symbols and outputting the transmitted message signal.

11. The transceiver system as claimed in claim 6, wherein the detector 160 executes NN based detectors having two-stages whose first stage estimates the non-linearity coefficient of the power amplifier from the received frame, which contains multiple symbols, and the second stage detects the original transmitted message in a one-hot encoded form by taking the frame and the estimated non-linearity coefficient from the first stage as inputs;
wherein switches (a) and (b) of the detector are in closed state which involves the detection-NN-model 410 to process entire frames of the OTFS symbols together to predict transmitted message frame by frame.

12. The transceiver system as claimed in claim 6, wherein the detector 160 executes Maximum Likelihood based detector having two stages in which the first stage estimates the non-linearity coefficient of power amplifier and in the second stage the said value of non-linearity is used to detect from the demodulated symbols and output the transmitted multidimensional symbols;
wherein the switches (a) and (c) in the detector 160 are in the closed state which involves the demodulator 161 to demodulate the received time domain signal and fed the same for data detection that has input from the calculating-NN-model element 400.

13. The transceiver system as claimed in claim 6, wherein the detector 160 has two stages of operation, wherein the non-linearity of the transmitting power amplifier is estimated by a calculating-NN-model in first stage and the said value is used by the detecting-NN-model along with the demodulated symbols which are output from the demodulator 161, to detect the original transmitted multidimensional symbols;
wherein the switches (a) and (d) of the detector 160 are in the closed state, whereby equalization is performed at the demodulated symbols and fed to ML detector 430 along with the estimated IBO enabling NN model 430 to take the input as [symbol] and [symbol] and IBO.

14. The transceiver system as claimed in claim 6, wherein the detector 160 executes an OTFS demodulator followed by a joint block of ML detector and Particle Filter (PF), whereby raw received signals are first demodulated using the demodulator 161 and then the demodulated symbols are used by the joint ML detector and PF to detect the original transmitted symbol, said PF takes a probabilistic approach of updating weight of each particle based on its likelihood relative to the observed symbols;
wherein the switch (e) of the detector 160 are in the closed state, whereby the estimated OTFS symbols are passed to joint ML detector and particle filter 440 to nullify nonlinearity due to the power amplifier and estimate the transmitted multi-dimensional symbols.

15. The transceiver system as claimed in claim 6, wherein the N-D converter 170 performs inverse operation of the I/Q converter 110 after estimating the symbol and the N-D signal de-mapper 180 demaps the symbol points in the N-D constellation using minimal distance judgment, the detected symbols are converted back to a stream of bits, whereby UE/BS receives the required information bits.
